(19) United States
(12) Patent Application Publication
(10) Pub. No.: US 2026/0056341 A1
(43) Pub. Date: Feb. 26, 2026

(54) SYSTEMS AND METHODS OF GENERATING AND USING PSEUDO-OFFSET GATHERS FOR SEISMIC IMAGING

(71) Applicant: ConocoPhillips Company, Houston, TX (US)

(72) Inventors: Zhengxue Li, Houston, TX (US); Leila Bencherif-Soerensen, Houston, TX (US)

(21) Appl. No.: 19/307,393

(22) Filed: Aug. 22, 2025

Related U.S. Application Data
(60) Provisional application No. 63/685,869, filed on Aug. 22, 2024.

(51) Int. Cl. G01V 1/34

(52) U.S. Cl. CPC G01V 1/345; G01V 2210/512

(57) ABSTRACT

System methods for generating a seismic image of a subterranean feature is provided. The method includes receiving an input gather representing the subterranean feature. The method further includes applying a pseudo offset header to the input gather to generate a pseudo-offset gather. Finally, the seismic image of the subterranean feature is generated by performing domain processing of the pseudo-offset gather. The method results in an improvement of structural imaging of obscured areas.

### CROSS-REFERENCE TO RELATED APPLICATIONS

The present application claims priority to U.S. Provisional Patent Application No. 63/685,869 filed on Aug. 22, 2024, which is incorporated by reference in its entirety herein.

### FIELD

The presently disclosed technology relates to modeling reservoirs and more particularly to seismic imaging using pseudo-offset gathers.

### BACKGROUND

Seismic imaging is used to understand the physical characteristics of a subterranean feature by converting seismic data into a 3D or 4D image. A given reservoir can have many variables that cause variations in the seismic responses. For example, seismically obscured areas (SOAs) are observed in imaging, caused, for example, by gas chimneys.

Seismic imaging can be obtained through many methods. One such method, reverse time migration (RTM), involves initiating a seismic waveform at a surface and recording and analyzing the reflected waveform to map subsurface features. The resulting gathers undergo post-processing to improve image quality.

Historically another method, Kirchhoff pre-stack depth migration (KPSDM), has been favored as it is less computationally intensive than RTM, and outputs gathers (based on a predefined offset, angle, or vector definition) allow for further refinement of the data prior to stacking.

It is with these observations in mind, among others, that various aspects of the present disclosure were conceived and developed.

### SUMMARY

Implementations described and claimed herein address the foregoing problems by providing a method for generating a seismic image of a subterranean feature. The method comprises receiving an input gather representing the subterranean feature and applying a pseudo offset header to the input gather to generate a pseudo-offset gather. The method further includes generating a seismic image of the subterranean feature by performing domain processing of the pseudo-offset gather.

Furthermore, in some instances, a method is described for generating a seismic image of a subterranean feature comprising determining a pseudo-offset header associated with an input gather of a subterranean feature and applying the pseudo offset header to the input gather to generate a pseudo-offset gather. The method further comprises generating a seismic image of the subterranean feature by performing domain processing of the pseudo-offset gather.

In some instances, a method is described for generating a seismic image of a subterranean feature comprising receiving an input gather representing the subterranean feature and data indicating a distance between a receiver and a location of the subterranean feature. Subsequently, the method includes generating a pseudo-offset header based on the distance between the receiver and the location of the subterranean feature and applying the pseudo offset header to the input gather to generate a pseudo-offset gather. Finally, the method includes generating the seismic image of the subterranean feature from the pseudo-offset gather.

Other implementations are also described and recited herein. Further, while multiple implementations are disclosed, still other implementations of the presently disclosed technology will become apparent to those skilled in the art from the following detailed description, which shows and describes illustrative implementations of the presently disclosed technology. As will be realized, the presently disclosed technology is capable of modifications in various aspects, all without departing from the spirit and scope of the presently disclosed technology. Accordingly, the drawings and detailed description are to be regarded as illustrative in nature and not limiting.

### BRIEF DESCRIPTION OF THE DRAWINGS

In order to describe the manner in which advantages and features of the presently disclosed technology can be obtained, a more particular description of the principles briefly described above will be rendered by reference to specific example implementations thereof which are illustrated in the appended drawings. Understanding that these drawings depict only exemplary implementations of the presently disclosed technology and are not therefore to be considered to be limiting of its scope, the principles herein are described and explained with additional specificity and detail through the use of the accompanying drawings in which: . . .

RTM is better able to handle complex velocity models than other known methods, producing better structural imaging of obscured areas than other methods, such as Kirchhoff pre-stack depth migration. RTM can also produce similar gather outputs, however, they are often extremely expensive. Surface Offset Gathers (SOGs) and angle gathers are expensive to produce at high frequencies. The pseudo-offset gathers described herein are a cost-effective alternative. RTM is modified to output ‘pseudo-offset-gathers’ that offer a post-imaging domain for subsequent processing before final stacking. The extra dimension offered by RTM allows for post-processing steps which are not applicable if only stack images are output. These post-processing steps include Q compensation, noise attenuation, and illumination compensation. This results in an improved 3D image and 4D response from the final stack of the RTM ‘pseudo-offset-gather-based’ data, both in structural aspects and signal-to-noise, compared to an equivalent Kirchhoff or ‘stack-based’ RTM product.

RTM uses wavefield propagation and is well suited to areas of complex geology or high-velocity contrasts where ray-based travel time computations are inaccurate. Smoothing of the velocity is also not needed for RTM ensuring that all details of the model are preserved. Additionally, illumination fields can be output for use in post-processing. The inclusion of Q to compensate for anelastic effects is well documented and is routinely applied to both imaging and velocity modelling.

A ‘stacked-based’ Q-RTM may be produced for each individual input (receiver) gather and then the input receiver location and output common-midpoint locations may be utilized to generate a ‘pseudo-offset’ value for each output bin. This is then repeated for each receiver in the survey to generate a ‘pseudo-offset-gather’. This provides an extra domain to sort and process the data prior to stacking, and it is not necessary to apply a mute before imaging as this can be done afterwards.

FIG. 1 illustrates an example network environment that may implement various systems and methods discussed herein;

FIG. 2 depicts a block diagram of a system of the pseudo-offset seismic imaging platform.

FIG. 3 depicts a flow diagram of the domain processing.

FIG. 4 depicts a detailed breakdown of the Illumination Compensation and Noise Attenuation post-processing steps.

FIG. 5 depicts RTM images before ICNA and after ICNA.

FIG. 6 depicts the removal of shallow footprints.

FIG. 7 depicts structural enhancement.

FIG. 8 depicts subsurface illumination improved by ICNA.

FIG. 9 shows an example of a computing system having one or more computing units that may implement various systems and methods discussed herein.

FIG. 10 depicts a method for generating a seismic image of a subterranean feature.

FIG. 11 depicts a workflow for generating a structural/3D pseudo-offset image.

FIG. 12 depicts a workflow for generating a time-lapse/4D pseudo-offset image.

FIG. 13 depicts images improved by 3D pseudo-offset gather imaging.

FIG. 14 depicts time-lapse images improved by 4D pseudo-offset gather imaging.

### DETAILED DESCRIPTION

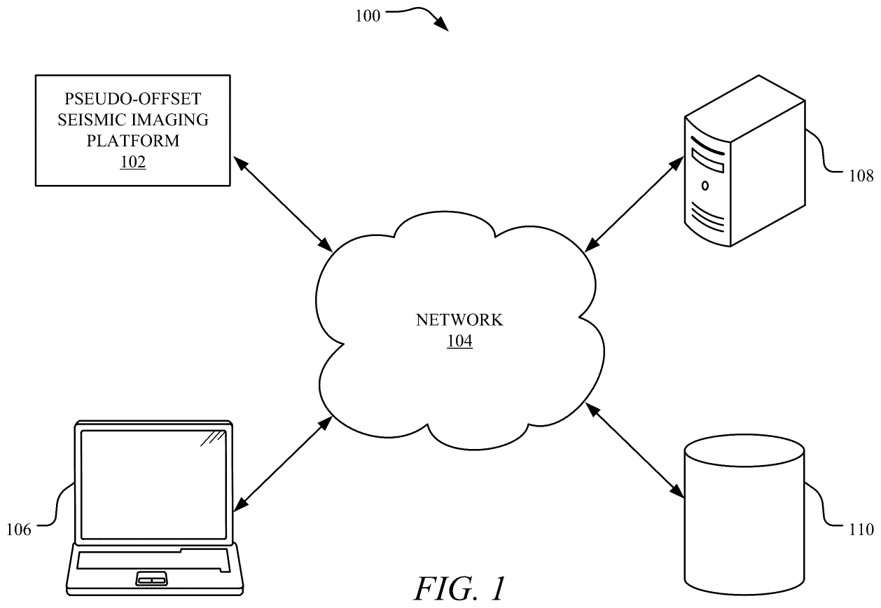

To begin a detailed discussion of an example system for generating seismic images by using pseudo-offset gathers, reference is made to FIG. 1. FIG. 1 illustrates an example network environment 100 for implementing the various systems and methods, as described herein including a pseudo-offset seismic imaging platform 102. A network 104 can be used by one or more computing or data storage devices for implementing the pseudo-offset seismic imaging platform 102. The pseudo-offset seismic imaging platform 102 may be a remote service, software as a service (SaaS) and/or cloud service for collecting and aggregating seismic data from multiple sources. The pseudo-offset seismic imaging platform 102 can include software modules for converting seismic data into seismic images, as discussed in greater detail below. For instance, any of the software operations (e.g., the computing system 900, etc.) discussed herein can be incorporated into the pseudo-offset seismic imaging platform 102 (e.g., as executable python script) to scale-up the software components and make them accessible to a variety of users in multiple locations using many different types of computing devices.

In some implementations, various components of the pseudo-offset seismic imaging platform 102, one or more user devices 106, one or more databases 110, and/or other network components or computing devices described herein are communicatively connected to the network 104. Examples of the user devices 106 include a terminal, personal computer, a smartphone, a tablet, a mobile computer, a workstation, and/or the like.

A server 108 may, in some instances, host the system including the pseudo-offset seismic imaging platform 102. In one implementation, the server 108 also hosts a website or an application that users may visit to access the network environment 100, including the pseudo-offset seismic imaging platform 102. The server 108 may be one single server, a plurality of servers with each such server being a physical server or a virtual machine, or a collection of both physical servers and virtual machines. In another implementation, a cloud hosts one or more components of the system. The pseudo-offset seismic imaging platform 102, the user devices 106, the server 108, and other resources connected to the network 104 may access one or more additional servers for access to one or more websites, applications, web services interfaces, etc. that are used for generating the seismic image.

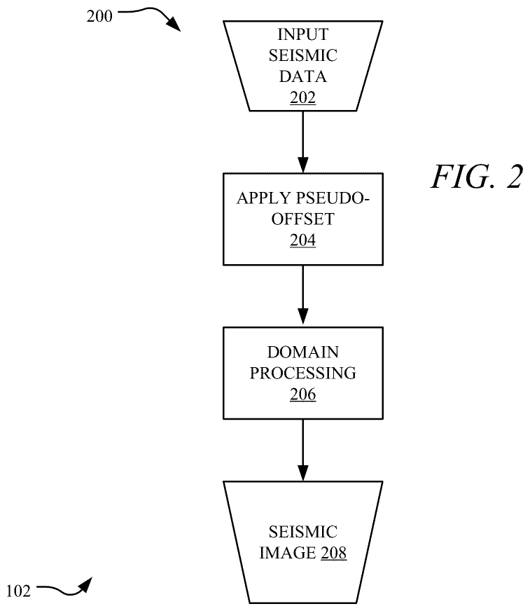

Turning to FIG. 2, a block diagram of a system 200 of the pseudo-offset seismic imaging platform 102 is depicted. The pseudo-offset seismic imaging platform 102 can perform operations to convert input seismic data 202 into 3D and/or 4D seismic images 208, for instance, by applying a pseudo-offset 204 to generate pseudo-offset gathers. The pseudo-offset gathers undergo further domain processing 206 and the seismic images are produced 208. The system 200 depicted in FIG. 2 can form at least a part of the network environment 100 or system depicted in FIG. 1.

In some examples, the input seismic data 202, which can be received by the pseudo-offset seismic imaging platform 102, includes a data of seismic information collected at a target location, which may include a subterranean feature. The input seismic data may be obtained using reverse time migration (RTM). The pseudo-offset header can be identified (e.g., selected and/or extracted) from the input seismic data 202 based on the distance between the receiver and the target location.

In some examples, after the pseudo-offset header is applied to the seismic data 202 to generate the pseudo-offset gather and domain processing 206 is performed on the generated pseudo-offset gather. The domain processing may include denoise and muting to remove residual multiples, converted waves, migrations swings, and post-critical energy. Muting may get rid of post critical angle contamination. In some instances, opening this additional domain (pseudo-offset domain) allows many other opportunities to further improve the seismic images, such as pre-stack domain Q amplitude compensation. Applications of this method may be particularly useful when applied to imaging of through-gas clouds (3D and 4D).

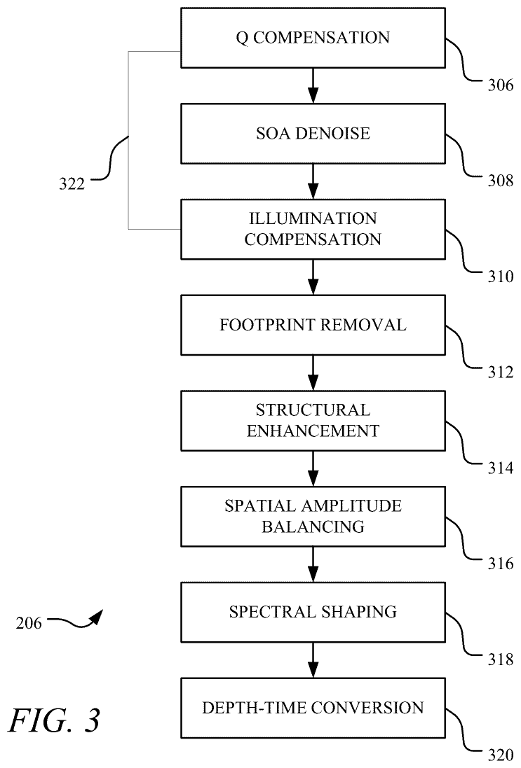

Turning to FIG. 3, a more detailed RTM domain processing 206 flow is shown. In some instances, this may be called post-processing. This flow allows for the output of pseudo-offset gathers from regular RTM and Q_{ref} RTM. RTM includes an extra dimension which allows for the post-processing flow, which is not applicable for stack images only. These steps include Q Compensation 306, SOA denoise 308, Illumination Compensation 310, Footprint Removal 312, Structural Enhancement 314, Spatial Amplitude Balancing 316, Spectral Shaping 318, and Depth-Time Conversion 320.

The steps of Q compensation 306, SOA denoise 308, and Illumination Compensation 310 are considered together as the Illumination Compensation and Noise Attenuation (ICNA) 322 post-processing steps for RTM pseudo-offset gathers.

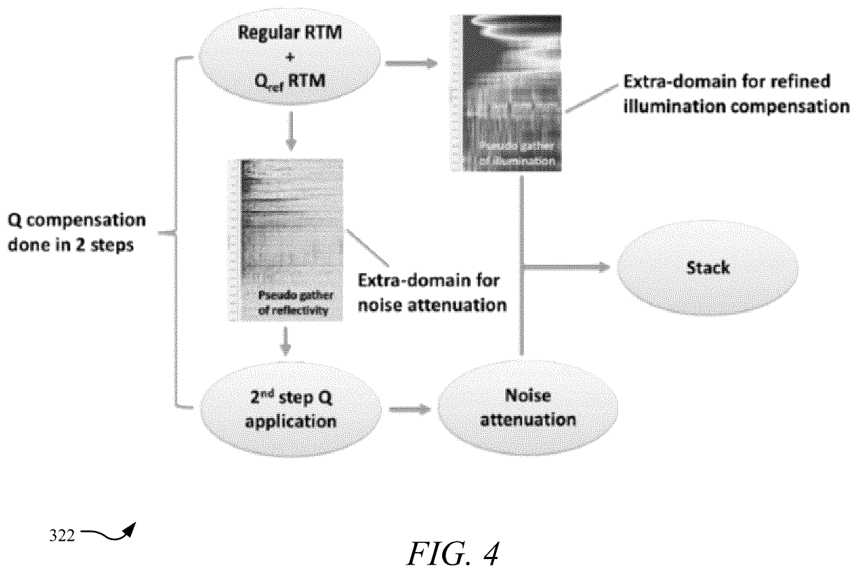

FIG. 4 shows a detailed breakdown of ICNA 322. As depicted in FIG. 4, the Q compensation is done in two steps. An extra domain is created for noise attenuation and an extra domain is created for illumination compensation.

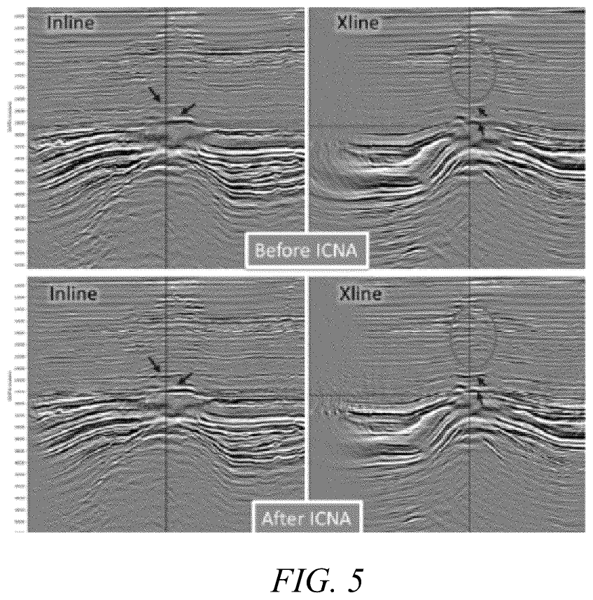

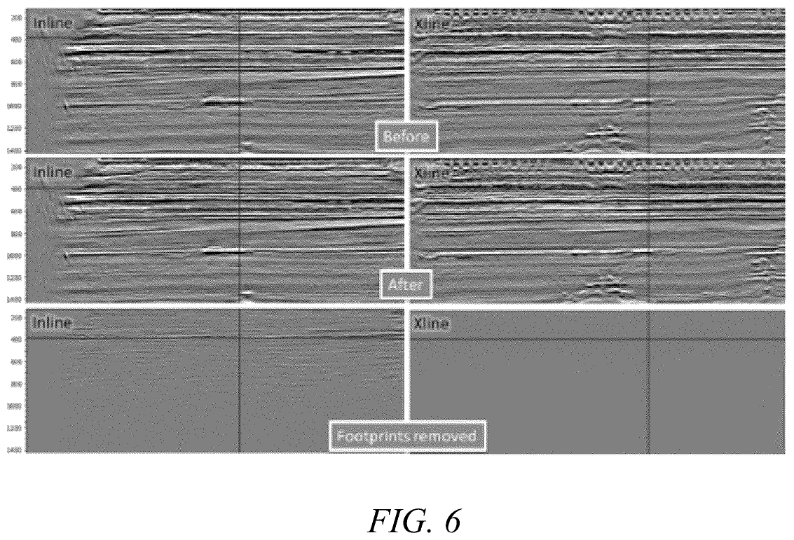

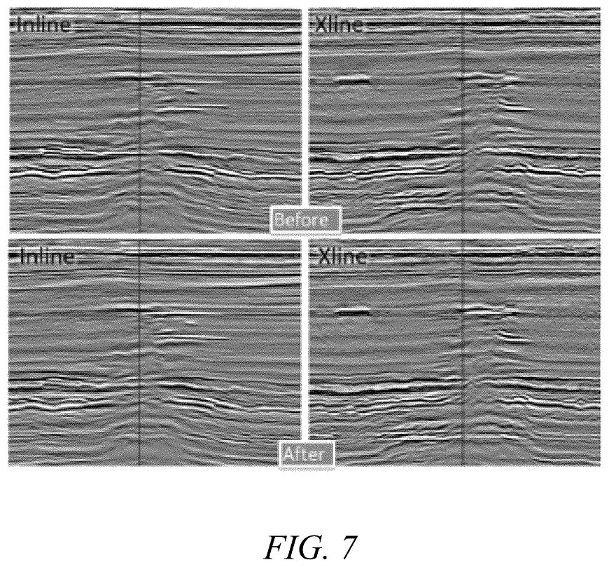

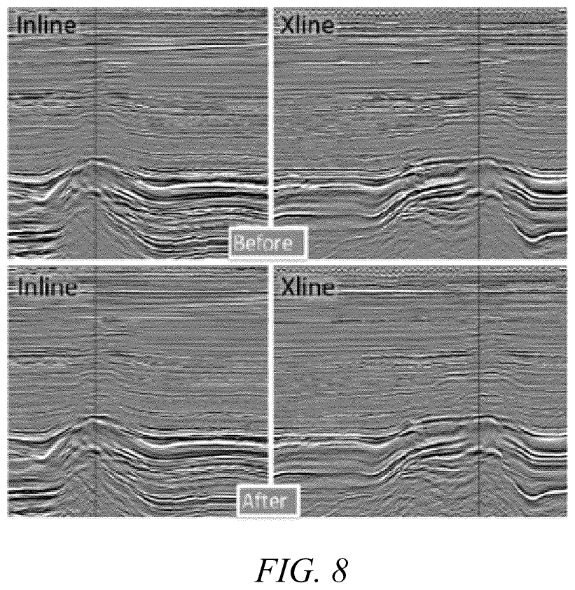

FIGS. 5-8 depict improvements in image quality at different stages of post-processing. FIG. 5 depicts RTM images before ICNA and after ICNA. Notably, the RTM images after ICNA are cleaner, sharper, and better illuminated inside the annotated SOA. The indicated circles show locations where residual multiples/noise have been attenuated using ICNA and the arrows show improvements in event sharpness and illumination. Turning to FIG. 6, following the ICNA process, shallow footprints are removed using K filters. FIG. 7 depicts structural enhancement using the application of SOS, an edge-preserving structure smoother which varies spatially in size and shape. The SOS is tuned to enhance planar features yet preserve event edges, such as faults. The smoothing applied is mild and only high frequency migration swings are attenuated in this process. Referring to FIG. 8, subsurface illumination has been greatly improved by ICNA. A spatially variant amplitude scalar was applied to the RTM images to get rid of long wavelength amplitude variations, and a more balance spatial amplitude distribution has been achieved for regions inside SOAs.

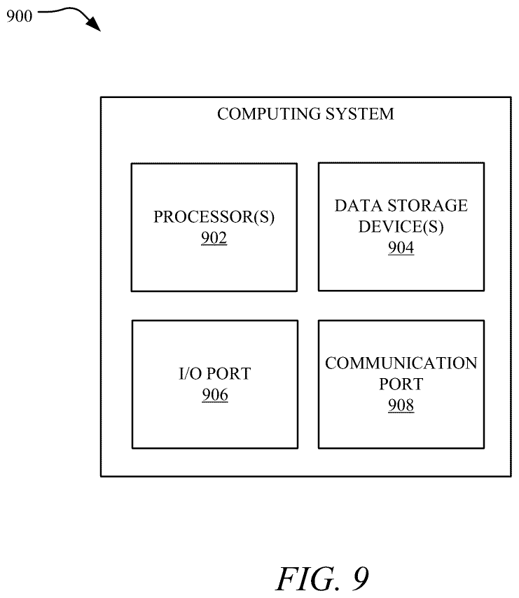

FIG. 9 shows an example of a computing system 900 having one or more computing units that may implement various systems and methods discussed herein is provided. The computing system 900 may be used to implement the pseudo-offset seismic imaging platform 102 as one or more software components, and can form a part of the network environment 100, and other computing or network devices. In some instances, the computing system 900 may be similar or identical to the user device 106, the server 108, the one or more databases 110, combinations thereof and the like. It will be appreciated that specific implementations of these devices may be of differing possible specific computing architectures not all of which are specifically discussed herein but will be understood by those of ordinary skill in the art.

The computing system 900 may be capable of executing a computer program product and/or a computer process. Data and program files may be input to the computing system 900, which reads the files and executes the programs therein. For instance, the computing system 900 can store the pseudo-offset seismic imaging platform 102 as one or more applications that receive various inputs (e.g., the input seismic data 202) and execute multiple algorithmic steps (e.g., as discussed herein), to generate the output seismic images 206.

Some of the elements of the computing system 900 are shown in FIG. 9, including one or more hardware processors 902, one or more data storage devices 904, such as memory devices, and/or one or more ports 906 or 908. Additionally, other elements that will be recognized by those skilled in the art may be included in the computing system 900 but are not explicitly depicted in FIG. 9 or discussed further herein. Various elements of the computing system 900 may communicate with one another by way of one or more communication buses, point-to-point communication paths, or other communication means not explicitly depicted in FIG. 9.

The processor 902 may include, for example, a central processing unit (CPU), a microprocessor, a microcontroller, a digital signal processor (DSP), and/or one or more internal levels of cache. There may be one or more processors 902, such that the processor 902 comprises a single central-processing unit, or a plurality of processing units capable of executing instructions and performing operations in parallel with each other, commonly referred to as a parallel processing environment.

The computing system 900 may be standalone computer, a distributed computer, or any other type of computer, such as one or more external computers made available via a cloud computing architecture. The presently described technology is optionally implemented in software stored on the data stored device(s) 904, (e.g., memory device(s)), and/or communicated via one or more of the ports 906 or 908, thereby transforming the computing system 900 in FIG. 9 to a special purpose machine for implementing the operations described herein. Examples of the computing system 900 include personal computers, terminals, workstations, mobile phones, tablets, laptops, personal computers, multimedia consoles, gaming consoles, set top boxes, and the like.

The one or more data storage devices 904 may include any non-volatile data storage device capable of storing data generated or employed within the computing system 900, such as computer executable instructions for performing a computer process, which may include instructions of both application programs and an operating system (OS) that manages the various components of the computing system 900. The data storage devices 904 may include, without limitation, magnetic disk drives, optical disk drives, solid state drives (SSDs), flash drives, and the like. The data storage devices 904 may include one or more memory devices such as removable data storage media, non-removable data storage media, and/or external storage devices made available via a wired or wireless network architecture with such computer program products, including one or more database management products, web server products, application server products, and/or other additional software components. Examples of removable data storage media include Compact Disc Read-Only Memory (CD-ROM), Digital Versatile Disc Read-Only Memory (DVD-ROM), magneto-optical disks, flash drives, and the like. Examples of non-removable data storage media include internal magnetic hard disks, SSDs, and the like. The one or more memory devices can include volatile memory (e.g., dynamic random access memory (DRAM), static random access memory (SRAM), etc.) and/or non-volatile memory (e.g., read-only memory (ROM), flash memory, etc.).

Computer program products containing mechanisms to effectuate the systems and methods in accordance with the presently described technology may reside in the data storage devices 904, which may be referred to as machine-readable media. It will be appreciated that machine-readable media may include any tangible non-transitory medium that is capable of storing or encoding instructions to perform any one or more of the operations of the present disclosure for execution by a machine or that is capable of storing or encoding data structures and/or modules utilized by or associated with such instructions. Machine-readable media may include a single medium or multiple media (e.g., a centralized or distributed database, and/or associated caches and servers) that store the one or more executable instructions or data structures. The machine-readable media may store instructions that, when executed by the processor, cause the systems to perform the operations disclosed herein.

In some implementations, the computing system 900 includes one or more ports, such as an input/output (I/O) port 906 and a communication port 908, for communicating with other computing, network, or reservoir development devices. It will be appreciated that the ports 906 and 908 may be combined or separate and that more or fewer ports may be included in the computing system 900.

The I/O port 906 may be connected to an I/O device, or other device, by which information is input to or output from the computing system 900. Such I/O devices may include, without limitation, one or more input devices, output devices, and/or environment transducer devices.

In some implementations, the input devices convert a human-generated signal, such as, human voice, physical movement, physical touch or pressure, and/or the like, into electrical signals as input data into the computing system 900 via the I/O port 906. Similarly, the output devices may convert electrical signals received from computing system 900 via the I/O port 906 into signals that may be sensed as output by a human, such as sound, light, and/or touch. The input device may be an alphanumeric input device, including alphanumeric and other keys for communicating information and/or command selections to the processor 902 via the I/O port 906. The input device may be another type of user input device including, but not limited to: direction and selection control devices, such as a mouse, a trackball, cursor direction keys, a joystick, and/or a wheel; one or more sensors, such as a camera, a microphone, a positional sensor, an orientation sensor, a gravitational sensor, an inertial sensor, and/or an accelerometer; and/or a touch-sensitive display screen (“touchscreen”). The output devices may include, without limitation, a display, a touchscreen, a speaker, a tactile and/or haptic output device, and/or the like. In some implementations, the input device and the output device may be the same device, for example, in the case of a touchscreen. Furthermore, the input devices and/or output devices can include a user interface (UI), for instance, to present the seismic images 206.

In some implementations, a communication port 908 is connected to a network (e.g., the network 104) by way of which the computing system 900 may receive network data useful in executing the methods and systems set out herein as well as transmitting information and network configuration changes determined thereby. Stated differently, the communication port 908 connects the computing system 900 to one or more communication interface devices configured to transmit and/or receive information between the computing system 900 and other devices by way of one or more wired or wireless communication networks or connections. Examples of such networks or connections include, without limitation, Universal Serial Bus (USB), Ethernet, Wi-Fi, Bluetooth®, Near Field Communication (NFC), Long-Term Evolution (LTE), and so on. One or more such communication interface devices may be utilized via the communication port 908 to communicate one or more other machines, either directly over a point-to-point communication path, over a wide area network (WAN) (e.g., the Internet), over a local area network (LAN), over a cellular (e.g., third generation (3G) or fourth generation (4G) or fifth generation (5G) network), or over another communication means. Further, the communication port 408 may communicate with an antenna or other link for electromagnetic signal transmission and/or reception.

The computing system 900 set forth in FIG. 9 is but one possible example of a computer system that may employ or be configured in accordance with aspects of the present disclosure. It will be appreciated that other non-transitory tangible computer-readable storage media storing computer-executable instructions for implementing the presently disclosed technology on a computing system may be used. In the present disclosure, the methods and operations disclosed herein may be implemented as sets of instructions or software readable by a device. These sets of instructions can convert the computing system 900 into a special purpose device for generating the seismic images 206 (e.g., a new type of file). As such, the computing system 800 can integrate the pseudo-offset seismic imaging platform 102 into a practical application by providing improved visualization the subterranean feature, thus improving the technological field of reservoir modeling for the oil/gas industry. For instance, the implementation of the pseudo-offset seismic imaging platform 102 on the computing system 900 can improve the identification of locally homogenous features and locations of such features, such that well construction placement is improved.

In some instances, the pseudo-offset seismic imaging platform 102 may be provided as a computer program product, or software, that may include a non-transitory machine-readable medium having stored thereon instructions, which may be used to program a computer system (or other electronic devices) to perform a process according to the present disclosure. A machine-readable medium includes any mechanism for storing information in a form (e.g., software, processing application) readable by a machine (e.g., a computer). The machine-readable medium may include, but is not limited to, magnetic storage medium, optical storage medium; magneto-optical storage medium, read only memory (ROM); random access memory (RAM); erasable programmable memory (e.g., EPROM and EEPROM); flash memory; or other types of medium suitable for storing electronic instructions.

The instructions, media for conveying such instructions, computing resources for executing them, and other structures for supporting such computing resources can be means for providing the functions described in these disclosures.

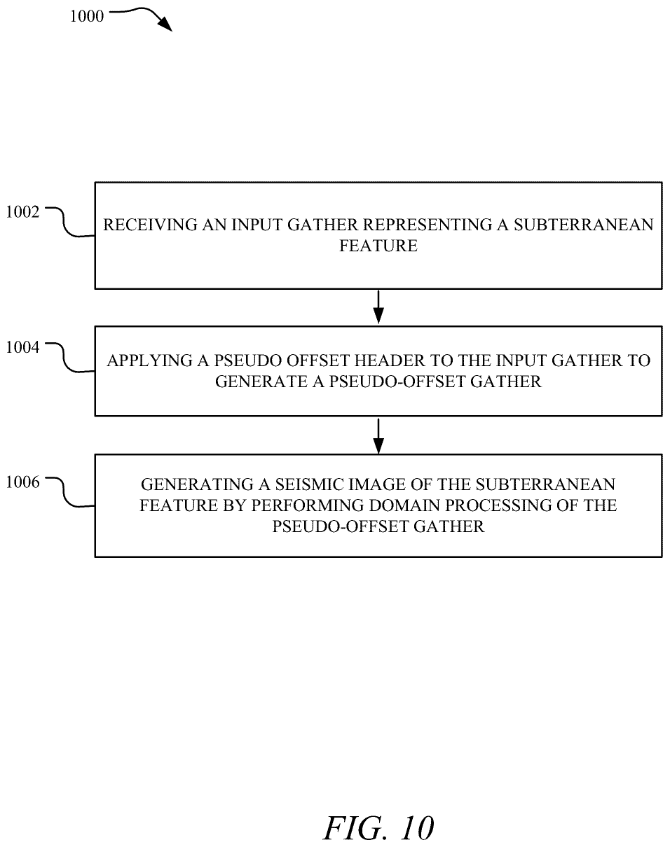

Turning to FIG. 10, an example method 1000 for generating a seismic image of a subterranean feature is shown. The method 1000 can be performed at least by the systems depicted in FIGS. 1-4.

In some examples, at operation 1002, the method 1000 receives an input gather representing a subterranean feature. At operation 1004, the method 1000 applies a pseudo offset header to the input gather to generate a pseudo-offset gather. At operation 1006, the method 1000 generates a seismic image of the subterranean feature by performing domain processing of the pseudo-offset gather.

It is to be understood that the specific arrangement, order, or hierarchy of steps or operations in the systems and methods depicted in FIG. 10 and throughout this disclosure are instances of example approaches and can be rearranged while remaining within the disclosed subject matter. For instance, any of the steps depicted in FIG. 10 and throughout this disclosure may be omitted, repeated, performed in parallel, performed in a different order, and/or combined with any other of the steps depicted in FIG. 10 and throughout this disclosure.

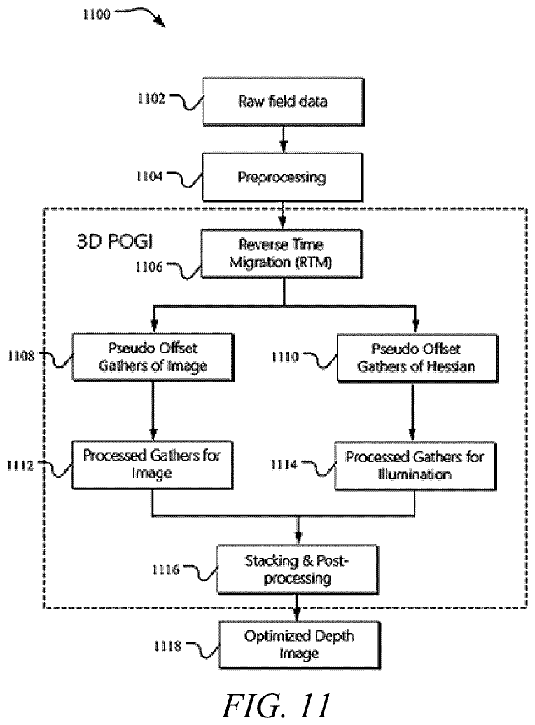

FIG. 11 depicts a workflow 1100 for generating a structural/3D pseudo-offset image. The workflow 1100 can be performed at least by the systems depicted in FIGS. 1-4. At operation 1102, raw field data is received. At operation 1104, the raw field data undergoes preprocessing. This preprocessing may include any of the methods described herein. At operation 1106, reverse time migration is performed, according to any of the methods described herein. At operation 1108, pseudo offset gathers of image are produced, and at operation 1110, pseudo offset gathers of hessian are produced. At operation 1112, the pseudo offset gathers of image are processed by one or more of angle muting, denoising, spectrum shaping, and/or gather flattening, to produce processed gathers for image. At operation 1114, the pseudo offset gathers of hessian are processed by one or more of angle muting, denoising, or smoothing, to produce processed gathers for illumination. At operation 1116, the processed gathers for image and processed gathers for illumination are combined for stacking and post-processing. Stacking and post-processing may be performed similarly to as described above. At operation 1118, the optimized depth image is produced.

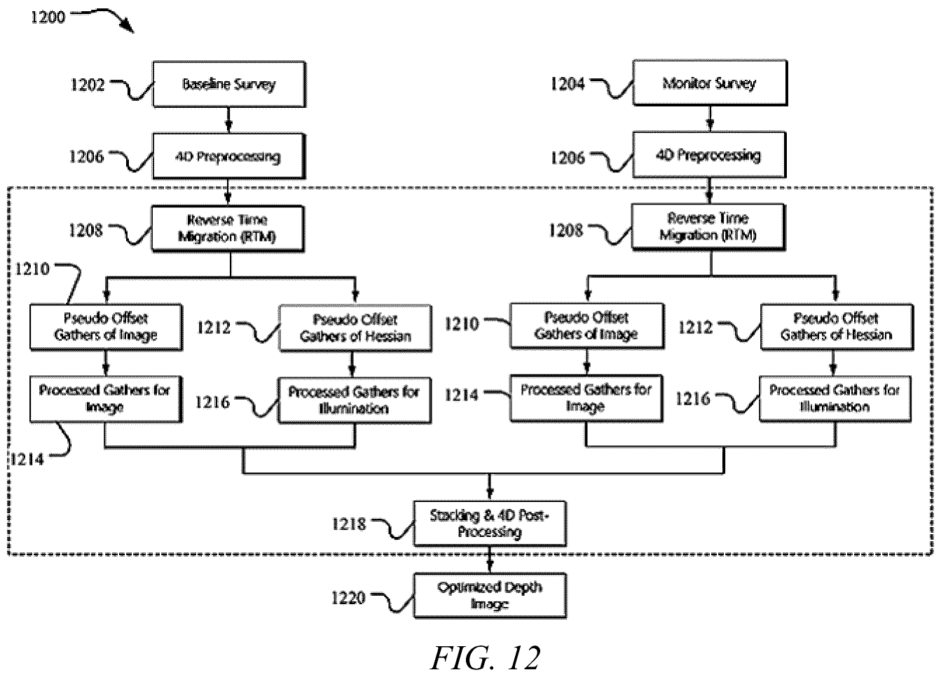

FIG. 12 depicts a workflow 1200 for generating a time-lapse/4D pseudo-offset image. At operation 1202, a baseline survey is received. At operation 1204, a monitor survey is received. Operation 1202 and 1204 may be performed concurrently. The following operations of workflow 1200 are the same for each of the baseline survey and the monitor survey. At operation 1206 the baseline survey and the monitor survey undergo 4D preprocessing. The preprocessing may be performed using any of the methods described herein. At operation 1208, reverse time migration is performed according to any of the methods described herein. At operation 1210, pseudo offset gathers of image are produced, and at operation 1212, pseudo offset gathers of hessian are produced. At operation 1214, the pseudo offset gathers of image are processed by one or more of angle muting, denoising, spectrum shaping, and/or gather flattening, to produce processed gathers for image. At operation 1216, the pseudo offset gathers of hessian are processed by one or more of angle muting, denoising, or smoothing, to produce processed gathers for illumination. At operation 1218, the processed gathers for image and processed gathers for illumination are combined for stacking and 4D post-processing. Stacking and post-processing may be performed similarly to as described above. At operation 1220, the optimized depth image is produced.

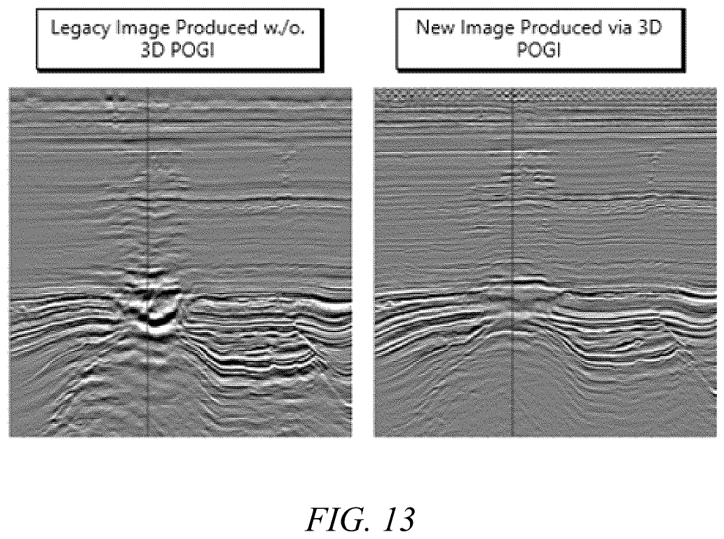

FIG. 13 depicts images improved by 3D pseudo-offset gather imaging. These images may be generated by the process described in relation to FIG. 11.

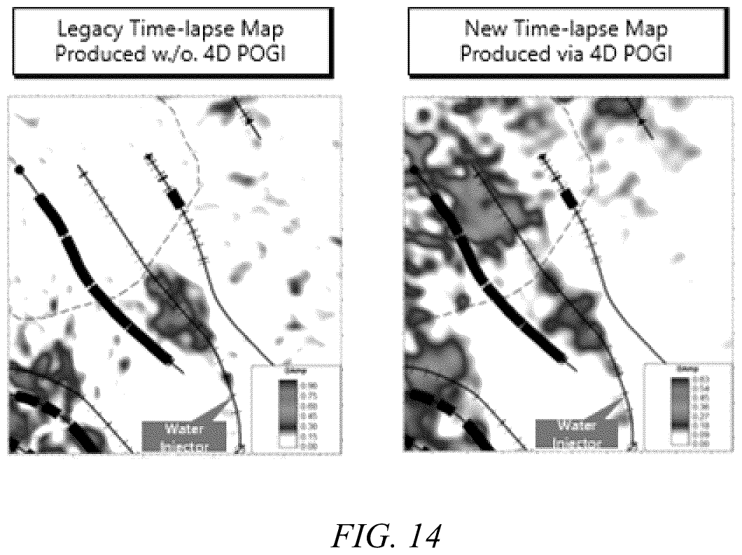

FIG. 14 depicts time-lapse images improved by 4D pseudo-offset gather imaging. These images may be generated by the process described in relation to FIG. 12.

While the present disclosure has been described with reference to various implementations, it will be understood that these implementations are illustrative and that the scope of the present disclosure is not limited to them. Many variations, modifications, additions, and improvements are possible. More generally, implementations in accordance with the present disclosure have been described in the context of particular implementations. Functionality may be separated or combined differently in various implementations of the disclosure or described with different terminology. These and other variations, modifications, additions, and improvements may fall within the scope of the disclosure as defined in the claims that follow.

What is claimed is:

1. A method for generating a seismic image of a subterranean feature, the method comprising:
receiving an input gather representing the subterranean feature;
applying a pseudo-offset header to the input gather to generate a pseudo-offset gather; and
generating the seismic image of the subterranean feature by performing domain processing of the pseudo-offset gather.

2. The method of claim 1, wherein the input gather is generated using a reverse time migration (RTM).

3. The method of claim 2, wherein the input gathers are pre-stack RTM gathers.

4. The method of claim 1, wherein performing domain processing of the pseudo-offset gather includes at least one of Q compensation, SOA denoise, illumination compensation, footprint removal, structural enhancement, spatial amplitude balancing, spectral shaping, or depth-time conversion.

5. The method of claim 4, wherein the Q compensation is performed in two steps.

6. The method of claim 1, wherein the pseudo-offset header is based on a distance between a receiver and a location of the subterranean feature.

7. The method of claim 1, wherein the generated seismic image is 3D or 4D.

8. The method of claim 1, further comprising presenting the seismic image at a display of a computing device to visually represent the subterranean feature.

9. A method for generating a seismic image of a subterranean feature, the method comprising:
determining a pseudo-offset header associated with an input gather of a subterranean feature;
applying the pseudo-offset header to the input gather to generate a pseudo-offset gather; and
generating the seismic image of the subterranean feature by performing domain processing of the pseudo-offset gather.

10. The method of claim 9, wherein the input gather is generated using a reverse time migration (RTM).

11. The method of claim 10, wherein the input gathers are pre-stack RTM gathers.

12. The method of claim 9, wherein performing domain processing of the pseudo-offset gather includes at least one of Q compensation, SOA denoise, illumination compensation, footprint removal, structural enhancement, spatial amplitude balancing, spectral shaping, or depth-time conversion.

13. The method of claim 12, wherein the Q compensation is performed in two steps.

14. The method of claim 9, wherein the pseudo-offset header is based on a distance between a receiver and a location of the subterranean feature.

15. The method of claim 9, wherein the generated seismic image is 3D or 4D.

16. The method of claim 9, further comprising presenting the seismic image at a display of a computing device to visually represent the subterranean feature.

17. A method for generating a seismic image of a subterranean feature, the method comprising:
receiving an input gather representing the subterranean feature;
receiving data indicating a distance between a receiver and a location of the subterranean feature;
generating a pseudo-offset header based on the distance between the receiver and the location of the subterranean feature;
applying the pseudo-offset header to the input gather to generate a pseudo-offset gather; and
generating the seismic image of the subterranean feature from the pseudo-offset gather.

18. The method of claim 17, wherein generating the seismic image includes performing domain processing.

19. The method of claim 17, wherein the input gather is generated using a reverse time migration (RTM).

20. The method of claim 19, wherein the input gathers are pre-stack RTM gathers.
